(19) United States
(12) Patent Application Publication
(10) Pub. No.: US 2013/0160950 A1
(43) Pub. Date: Jun. 27, 2013

(54) PLASMA PROCESSING APPARATUS

(71) Applicant: Samsung Electronics Co., Ltd., Suwon-Si (KR)

(72) Inventors: Hyungjoon KIM, Suwon-si (KR); Sangheon LEE, Seongnam-si (KR); Sang Jean JEON, Hwaseong-si (KR); Ji Myoung LEE, Seoul (KR); Yunkwang JEON, Seoul (KR)

(73) Assignee: SAMSUNG ELECTRONICS CO., LTD., Suwon-Si (KR)

(21) Appl. No.: 13/724,794

(22) Filed: Dec. 21, 2012

(30) Foreign Application Priority Data
Dec. 22, 2011 (KR) 10-2011-0140568

(51) Int. Cl. H05H 1/46

(52) U.S. Cl. CPC H05H 1/46
USPC 156/345.48; 118/723 I

(57) ABSTRACT

A plasma processing apparatus capable of adjusting a processing rate (e.g., etching or deposition rate) of a sample locally by adjusting a plasma density may be provided. For example, the plasma processing apparatus may include a processing chamber, an antenna coil inside the processing chamber to generate magnetic field, and a magnetic field blocking member configured to block the magnetic field generated at the antenna coil such that an intensity of the magnetic field is controlled by adjusting a gap distance between the magnetic field blocking member and the antenna coil. According to the plasma processing apparatus, an asymmetric etching of the sample can be minimized.

### CROSS-REFERENCE TO RELATED APPLICATION

This application claims priority under 35 U.S.C. § 119 to Korean Patent Application No. 2011-0140568, filed on Dec. 22, 2011, in the Korean Intellectual Property Office, the disclosure of which is incorporated herein by reference in its entirety.

### BACKGROUND

1. Field

Example embodiments relate to a plasma processing apparatus capable of processing a substrate by generating uniform, high density plasma.

2. Description of the Related Art

Plasma, as ionized gas, is composed of ion, electron, and radical. Because the electrical characteristics and heat-related characteristics of plasma greatly differ from ordinary gases, plasma is also referred to as a fourth state of matter. Because plasma includes ionized gas, when electric field and/or magnetic fields are applied to plasma, plasma particles are accelerated or dispersed at an inside of the plasma or at the surface of solid matter that is in contact with the plasma, and thus chemical and/or physical reactions occur on the surface of the solid matter. In a semiconductor manufacturing process during which fine patterns are needed to be formed on a semiconductor wafer or a glass substrate of a liquid crystal display, various surface treatment processes using plasma, e.g., an etching and a deposition, are performed.

In recent years, as the degree of integration of a semiconductor device increases, the widths of fine patterns became narrower. Accordingly, to improve the uniformity of plasma used in a fine patterning process, a plasma processing apparatus capable of generating high-density plasma is demanded. As for the high-density plasma processing apparatuses, Inductively Coupled Plasma (ICP) apparatus and Capacitively Coupled Plasma (CCP) apparatus, for instance, are being used. The Inductively Coupled Plasma (ICP) apparatus, which uses electromagnetic energy for plasma processing, provides less plasma loss, even when a sample, e.g., a semiconductor wafer or a glass substrate, is at an outside of the influence area of the electromagnetic energy. Accordingly, the Inductively Coupled Plasma (ICP) is being widely used.

The Capacitively Coupled Plasma (CCP) apparatus having an antenna, which is to receive a radio-frequency power, is installed at an upper portion of a chamber in which plasma is to be generated. By applying the radio-frequency power to the antenna, the Capacitively Coupled Plasma (CCP) forms an induced electric field at an inside of the chamber. The induced electric field ionizes and injects gases into the chamber to perform an etching or a deposition on a semiconductor wafer or a glass substrate loaded at a chuck inside the chamber.

### SUMMARY

At least one embodiment is related to a plasma processing apparatus capable of adjusting a processing rate by each section with respect to a sample by adjusting plasma density.

According to an example embodiment, a plasma processing apparatus includes a processing chamber, an antenna coil and a magnetic field blocking member. The antenna coil may be provided inside the processing chamber, and configured to generate a magnetic field. The magnetic field blocking member may be configured to block the magnetic field being generated at the antenna coil such that an intensity of the magnetic field is controlled by adjusting a gap distance between the magnetic field blocking member and the antenna coil.

The magnetic field blocking member may be installed at an inner side of the processing chamber by a coupling pin. The coupling pin may be rotatable. The magnetic field blocking member is configured to move by the rotating the coupling pin. The magnetic field blocking member may be configured to move at least one of toward an inner side direction of the processing chamber and toward an outer side direction of the processing chamber.

The magnetic field blocking member may be configured in a way that, as the magnetic field blocking member moves toward the inner side direction of the processing chamber to be nearer to the antenna coil, the amount of the magnetic field blocked by the magnetic field blocking member is increased.

The magnetic field blocking member may be configured in a way that, as the magnetic field blocking member moves toward the outer side direction of the processing chamber to be farther away from the antenna coil, the amount of the magnetic field blocked by the magnetic field blocking member is reduced. The plasma processing apparatus may further include a dielectric panel provided inside the processing chamber. An induced current may be generated at the dielectric panel as the magnetic field penetrates through the dielectric panel.

The processing chamber may define a reaction space therein, and the plasma is generated at the reaction space by the magnetic field of induced current generated at the dielectric panel. A lower electrode may be provided at the reaction space and a sample to be processed by the plasma may be placed on the lower electrode.

The magnetic field blocking member may be provided in the processing chamber. The magnetic field blocking member may be configured to move in a circumferential direction of the antenna coil to a position above the sample, and may be configured to move in a radial direction of the processing chamber to adjust the gap distance between the magnetic field blocking member and the antenna coil.

According to an example embodiment, a plasma processing apparatus includes an upper processing chamber, a lower processing chamber, and a magnetic field blocking member at the upper processing chamber. The upper processing chamber may be provided with an antenna coil. that the antenna coil may be configured to generate magnetic field by using a radio-frequency power from a power supply unit. The lower processing chamber may be configured to house a sample to be processed by a plasma. A density of the plasma may be configured to be adjusted according to an intensity of the magnetic field of the antenna coil. A magnetic field blocking member may be provided at the upper processing chamber, and may be configured to move in a radial direction of the antenna coil to adjust a gap distance between the magnetic field blocking member and the antenna coil.

The magnetic field blocking member may be installed at an inner side of the upper processing chamber by a coupling pin. The coupling pin may be rotatable. The magnetic field blocking member, by rotating the coupling pin, may be configured to move at least one of toward an inner side direction of the upper processing chamber and toward an outer side direction of the upper processing chamber.

The magnetic field blocking member may be configured in a way that, as the magnetic field blocking member moves toward the inner side direction of the upper processing chamber to be nearer to the antenna coil, the amount of the magnetic field blocked by the magnetic field blocking member is increased.

The magnetic field blocking member may be configured in a way that, as the magnetic field blocking member moves toward the outer side direction of the upper processing chamber to be farther away from the antenna coil, the amount of the magnetic field blocked by the magnetic field blocking member is reduced.

The plasma processing apparatus may further include a dielectric panel provided at a border of the upper processing chamber and the lower processing chamber such that an induced current is generated as the magnetic field penetrates through the dielectric panel.

The lower processing chamber defines a reaction space therein, and the plasma is generated at the reaction space by the magnetic field of induced current generated at the dielectric panel. A lower electrode may be provided at the reaction space, and a sample to be processed by the plasma may be placed on the lower electrode.

The magnetic field blocking member may be provided in the upper processing chamber. The magnetic field blocking member may be configured to move in a circumferential direction of the antenna coil such that the magnetic field blocking member is positioned at an upper portion of a domain of the sample, the domain being a location at which an processing rate needs to be adjusted. The magnetic field blocking member may be configured to move in a radial direction of the upper processing chamber to adjust a gap distance between the magnetic field blocking member and the antenna coil.

The magnetic field blocking member may be configured to extend in a circumferential direction.

The magnetic field blocking member may be provided in the shape of a planar shape at an inside the processing chamber.

A plasma processing apparatus includes a processing chamber including a first processing area and a second processing area, an antenna coil in the first processing area, a dielectric plate between the first processing area and the second processing area, and at least one magnetic field blocking member in the first processing area. The antenna coil is configured to generate a magnetic field. The dielectric plate is configured to generate an inductive current by the magnetic field, and the inductive current generating a plasma in the second processing area. The at least one magnetic field blocking member is configured to control an intensity of the magnetic field by adjusting a gap distance between the at least one magnetic field blocking member and the antenna coil.

The at least one magnetic field blocking member may be configured to move in a circumferential direction with respect to a circumference of the first processing area and be configured to move in a radial direction with respect to a center of the first processing area.

The first processing area may be configured to move separately from the second processing area.

The first processing area and the at least one magnetic field blocking member may be coupled with each other and move together in a circumferential direction with respect to a circumference of the first processing area.

The at least one magnetic field blocking member may be a plurality of magnetic field blocking members. Positions of each of the plurality of magnetic field blocking members may be configured to be adjusted separately from each other.

Meanwhile, according to one aspect of the present inventive concepts, because the density of the plasma being generated at a plasma processing apparatus may be adjusted by section, an asymmetric processing of a sample may be reduced or prevented.

### BRIEF DESCRIPTION OF THE DRAWINGS

These and/or other aspects of the present inventive concepts will become apparent and more readily appreciated from the following description of the example embodiments, taken in conjunction with the accompanying drawings of which:

FIG. 1 is a schematic structural view of a plasma processing apparatus in accordance with an example embodiment.

FIG. 2 is a conceptual drawing illustrating an inductive current formed at a dielectric panel of a plasma processing apparatus in accordance with an example embodiment.

FIG. 3 is a conceptual drawing illustrating an operation of reducing an processing rate by blocking a magnetic field, which reaches a dielectric panel of a plasma processing apparatus in accordance with an example embodiment.

FIG. 4 is a partial perspective view illustrating a magnetic field blocking member of a plasma processing apparatus in accordance with an example embodiment.

FIGS. 5A and 5B are drawings illustrating an operation of a magnetic field blocking member of a plasma processing apparatus in accordance with an example embodiment.

FIGS. 6A and 6B are drawings illustrating an operation of a magnetic field blocking member of a plasma processing apparatus in accordance with another example embodiment.

FIG. 7A is a drawing illustrating a state of a plasma-etched sample prior to providing a magnetic field blocking member into a plasma etching apparatus.

FIG. 7B is a drawing illustrating a state of a plasma-etched sample after adjusting a gap distance using a magnetic field blocking member, which is provided in a plasma etching apparatus, in accordance with an example embodiment.

FIG. 8A is a partial schematic perspective view illustrating a magnetic field blocking member provided in a plasma processing apparatus in accordance with an example embodiment.

FIG. 8B is a partial perspective view illustrating a magnetic field blocking member provided in a plasma processing apparatus in accordance with an example embodiment.

FIG. 8C is a plane view illustrating a magnetic field blocking member provided in a plasma processing apparatus in accordance with an example embodiment.

FIG. 8D is a plane view illustrating a magnetic field blocking member provided in a plasma processing apparatus in accordance with an example embodiment.

### DETAILED DESCRIPTION

Example embodiments will now be described more fully with reference to the accompanying drawings. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements throughout, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

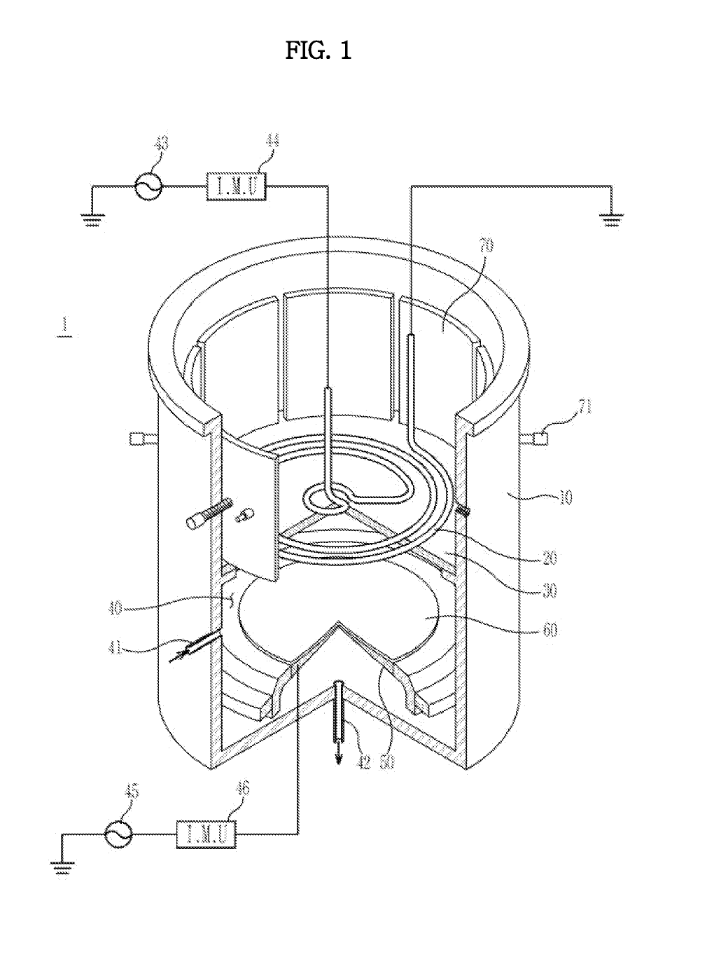

FIG. 1 is a schematic structural view of a plasma processing apparatus in accordance with an example embodiment.

A plasma processing apparatus 1 may include a processing chamber 10, an antenna coil 20, and a dielectric panel 30.

The processing chamber 10 is configured to form a reaction space 40, at which plasma is generated. At the processing chamber 10, a gas inlet unit 41, through which source gas is introduced, is provided. The source gas, in a case that the purpose of a process is an etching, may be at least one of gases, which is selected from SF₆, CH₂, HCl, CF₄, O₂, He, and Ar. The source gas, in a case that the purpose of a process is a deposition, may be at least one of gases, which is selected from SiH₄, CH₄, NH₃, and N₂. To uniformly supply reaction gas into the processing chamber 10, a plurality of gas inlet units 41 may be provided.

At a lower domain of the processing chamber 10, a gas discharging unit 42 may be provided such that the reaction gas having completed a reaction and by-products from a processing (e.g., etching, deposition, etc.) may be discharged to an outside. The position and the number of the gas discharging unit 42 may be adjusted in various manner. The gas discharging unit 42 may be connected to a vacuum pump (not shown). The vacuum pump may be configured to efficiently discharge the reaction gas having completed a reaction and by-products from a processing to the outside, and may also be configured to properly maintain the degree of vacuum in the processing chamber 10.

At an upper portion of the reaction space 40, the antenna coil 20 may be positioned. The antenna coil 20 is connected to an upper power supply unit 43 that is configured to apply a radio-frequency power. Between the antenna coil 20 and the upper power supply unit 43, an upper impedance matching unit 44 may be provided.

Between the reaction space 40 and the antenna coil 20, the dielectric panel 30 may be positioned. The antenna coil 20 and the dielectric panel 30 may be disposed in parallel to each other while having a desired (or alternatively, predetermined) space therebetween.

At a lower portion of the reaction space 40, a lower electrode 50 may be provided. The lower electrode 50 may be in the form of a panel, and may be disposed in parallel to the dielectric panel 30. On the lower electrode 50, a sample 60 is placed, and thus the size of the lower electrode 50 may be larger than that of the sample 60. The lower electrode 50 is connected to a lower power supply unit 45 configured to apply a radio-frequency power. Between the lower electrode 50 and the lower power supply unit 45, a lower impedance matching unit 46 may be provided. When radio-frequency power is applied to the lower electrode 50, plasma may be formed in the reaction space 40 in a more uniform manner.

On the lower electrode 50, the sample 60, which is the subject of a treatment, may be placed. The sample 60 may be, e.g., a semiconductor wafer, a thin transistor substrate of a liquid crystal display apparatus, or a color filter substrate of a liquid crystal display apparatus.

Inside the processing chamber 10, at least one magnetic field blocking member 70, which is configured to block a magnetic field generated at the antenna coil 20, may be installed. The magnetic field blocking member 70, by blocking a portion of the magnetic field generated at the antenna coil 20, may adjust the processing rate (e.g., etching rate) of the sample 60 placed on the lower electrode 50.

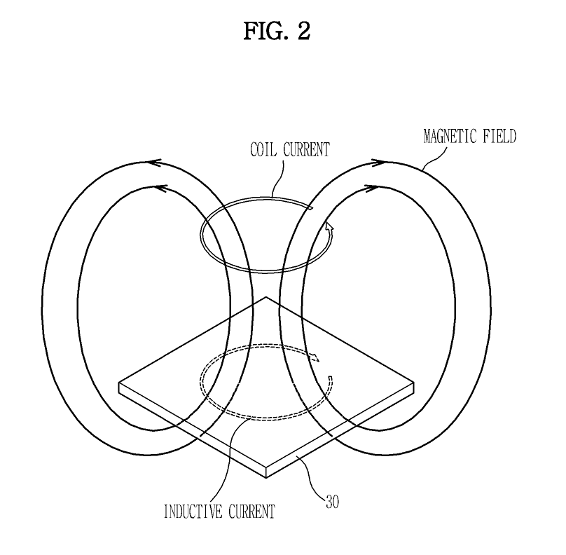

Hereinafter, a principle of a magnetic field being applied to the reaction space 40 of the plasma processing apparatus 1 will be described by referring to FIG. 2, and an operation of the magnetic field blocking member 70 will be described later in detail.

FIG. 2 is a conceptual drawing illustrating an inductive current formed at a dielectric panel of a plasma processing apparatus in accordance with an example embodiment.

When the upper power supply unit 43 applies a radio-frequency power to the antenna coil 20, current flows in a counter-clockwise direction at the antenna coil 20. When current flows at the antenna coil 20 in a counter-clockwise direction, a magnetic field that penetrates the dielectric panel 30 positioned at a lower portion of the antenna coil 20 is generated by the current of the antenna coil 20. At this time, at the dielectric panel 30 positioned at a lower portion of the antenna coil 20, an inductive current, direction of which is opposite to the direction of the current at the antenna coil 20 (i.e., in a clockwise direction), is generated.

The reasons for the inductive current being generated are as follows. When a conductor is placed near the antenna coil 20 at which alternating current (AC) flows, the magnetic field generated at the surroundings of the antenna coil 20 may affect the conductor. At this time, electromotive force interfering with a magnetic flux, which penetrates the conductor, is generated. This phenomenon is referred to as an electromagnetic induction, and the current formed at the conductor by the electromotive force is referred to as inductive current or Eddy current.

As the magnetic field of the inductive current generated at the dielectric panel 30 is applied to the reaction space 40, plasma may be generated.

Accordingly, by adjusting the amount of the magnetic field generated at the antenna coil 20 and reached at the dielectric panel 30, the generation of plasma may be controlled, and thus an processing rate may be adjusted.

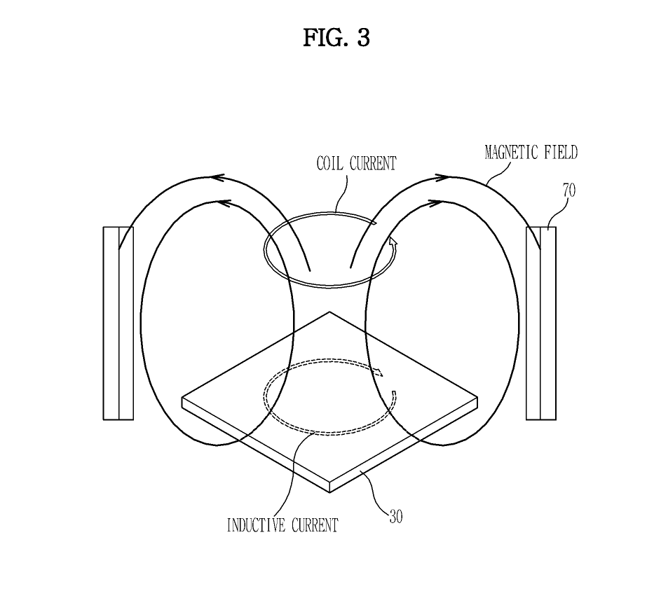

FIG. 3 is a conceptual drawing illustrating an operation of reducing an processing rate by blocking a magnetic field, which reaches a dielectric panel of a plasma processing apparatus in accordance with an example embodiment.

When the upper power supply unit 43 applies a radio-frequency power to the antenna coil 20, current flows in a counter-clockwise direction at the antenna coil 20. When current flows at the antenna 20 in a counter-clockwise direction, a magnetic field that penetrates the dielectric panel 30 positioned at a lower portion is generated by the current of the antenna coil 20.

At this time, when the magnetic field blocking member 70 blocks a portion of the magnetic field being generated at the antenna coil 20, the intensity of the magnetic field that penetrates the dielectric panel 30 is reduced, When the intensity of the magnetic field penetrating the dielectric panel 30 is reduced, the inductive current generated thereby is also reduced, and thus an processing rate of plasma is reduced.

In detail, the magnetic field blocking member 70 may be installed at an inner side wall of the processing chamber 10. The magnetic field blocking member 70 may be moved toward an inner radial direction or an outer radial direction of the processing chamber 10. When the magnetic field blocking member 70 is moved toward an inner radial direction of the processing chamber 10, the distance with respect to the antenna coil 20 becomes closer. When the distance from the magnetic field blocking member 70 to the antenna coil 20 become closer, the magnetic field generated at the antenna coil 20 is blocked more by the magnetic field blocking member 70. The degree of the magnetic field being blocked may be varied by the distance from the magnetic field blocking member 70 and the antenna coil 20. When the distance from the magnetic field blocking member 70 to the antenna coil 20 becomes smaller, more of the magnetic field generated at the antenna coil 20 is blocked. A state that most of the magnetic field is blocked may be represented such that the most of the magnetic field lines from the antenna coil 20 are blocked. Meanwhile, when the distance from the magnetic field blocking member 70 to the antenna coil 20 becomes greater, most of the magnetic field generated at the antenna coil 20 is not blocked. A state that most of the magnetic field is not blocked may be represented such that most of the magnetic field lines from the antenna coil 20 are not blocked and are delivered to the dielectric panel 30, thereby generating an inductive current.

Hereinafter, a structure and an operation of the magnetic field blocking member 70 will be described in detail.

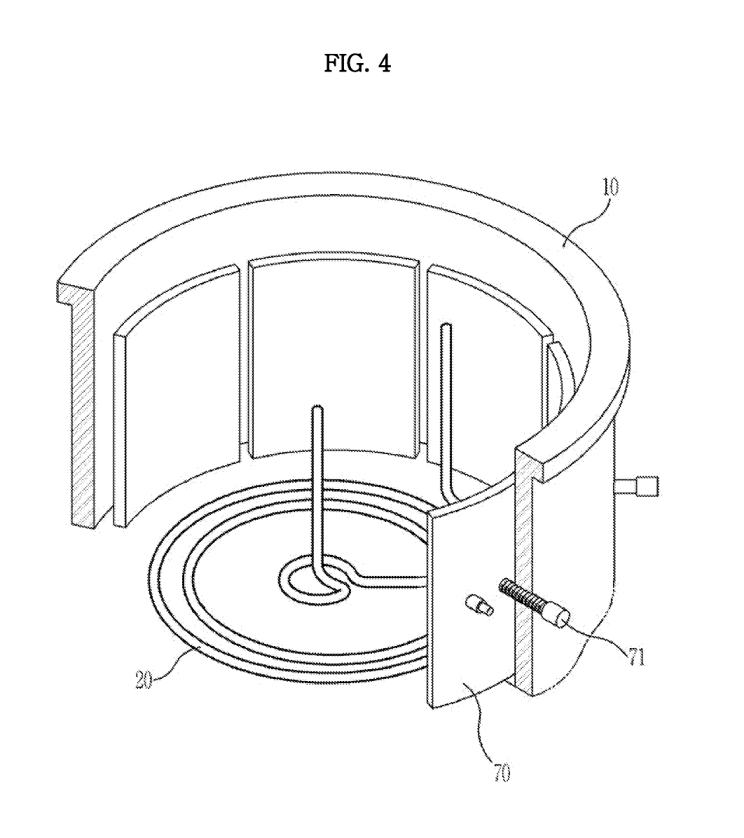

FIG. 4 is a partial perspective view illustrating a magnetic field blocking member of a plasma processing apparatus in accordance with an example embodiment.

The magnetic field blocking member 70 may be provided between an inner wall of the processing chamber 10 and the antenna coil 20. The magnetic field blocking member 70 may be connected to an inner wall of the processing wall 10 using a coupling pin 71. The coupling pin 71 may be attached to the magnetic field blocking member 70. For example, the coupling pin 71 may be moved in an outer radial direction or in an inner radial direction of the processing chamber 10 by rotating the coupling pin 71. The coupling pin 71 may be rotated automatically or manually. For example, a step motor (not shown) may be connected to the coupling pin 71 and automatically rotate the coupling pin by driving the step motor. The coupling pin 71 may be manually rotated by manually rotating the coupling pin 71. The degree of rotating the coupling pin 71 may be determined by checking an processing state of the sample 60. After checking thicknesses at a plurality of points of the sample 60, if the processing rate of a particular point is higher than other points, the inductive current of an upper vertical domain of the location at which the particular point is positioned may be reduced. For example, the magnetic field blocking member 70, which is positioned at the upper vertical domain of the location having higher processing rate, may be adjusted to a position adjacent to the antenna coil 20 such that some of the generated magnetic field is blocked to achieve a desired processing rate. Depending on the degree of the processing rate to be reduced, the moving distance of the magnetic field blocking member 70 may be adjusted.

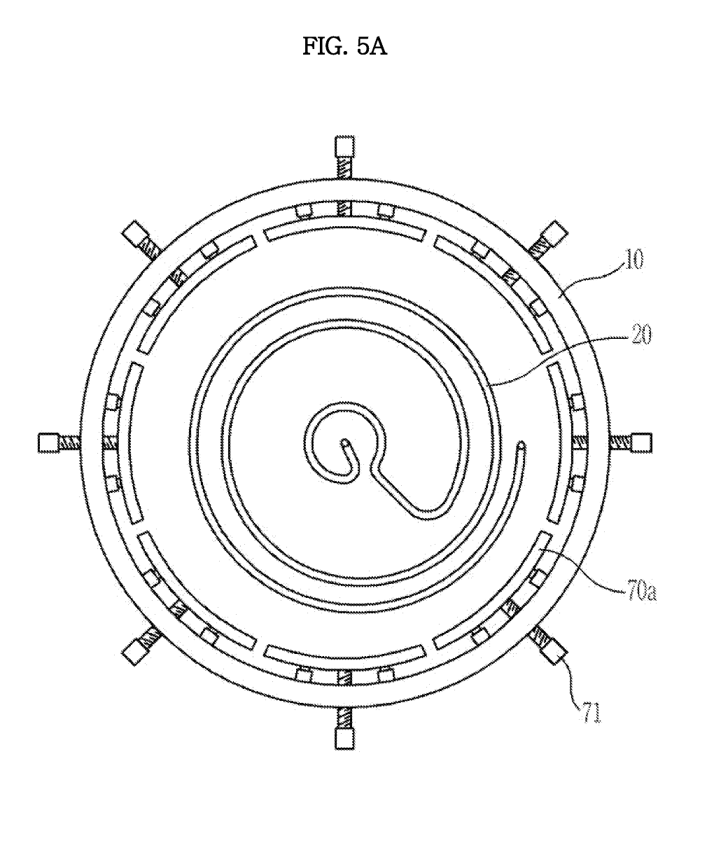

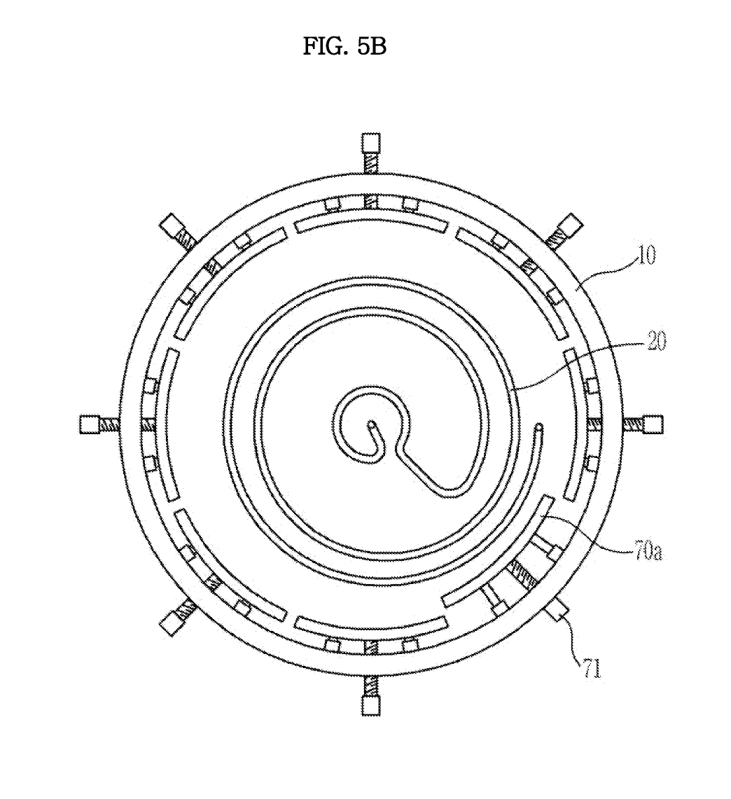

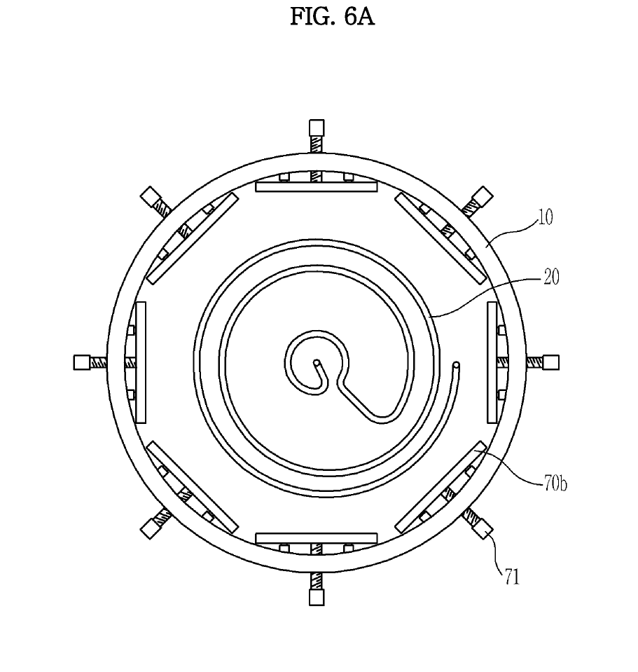

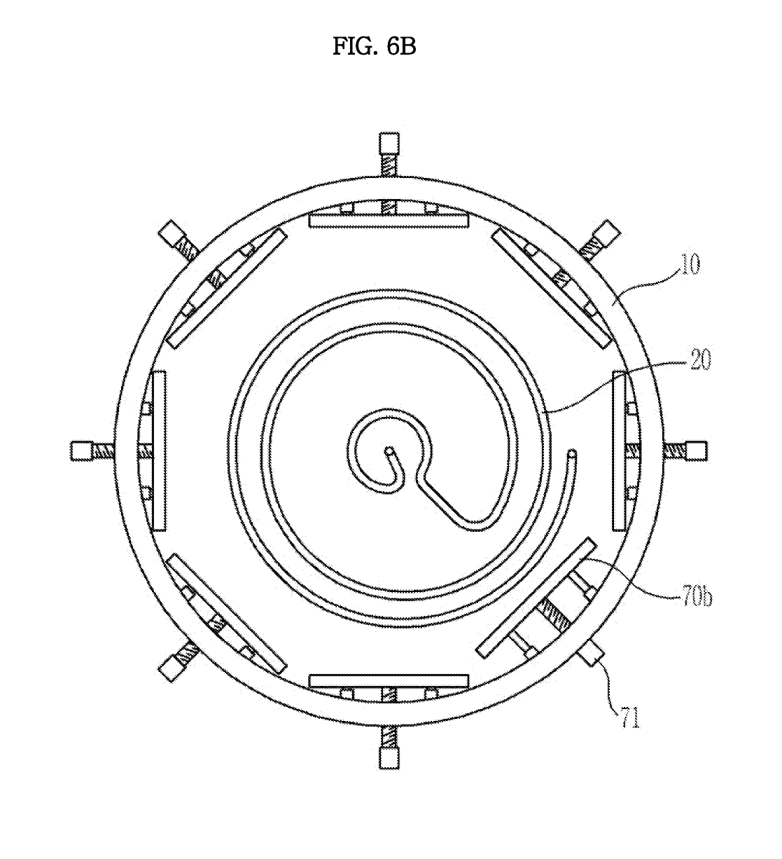

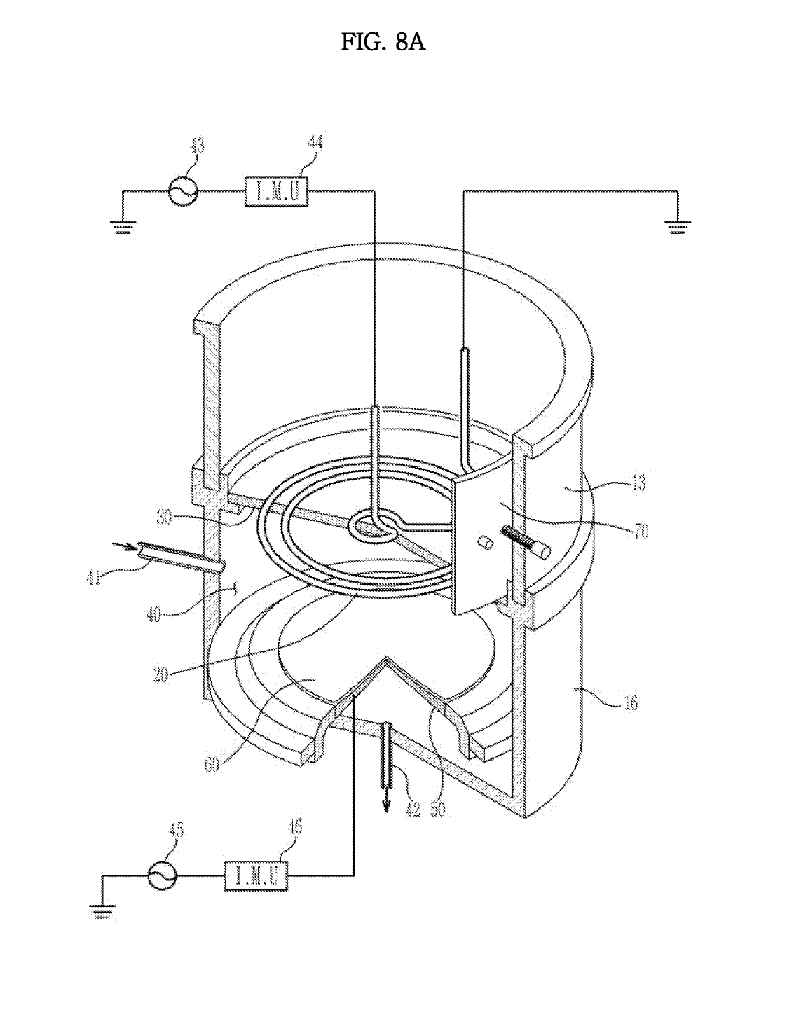

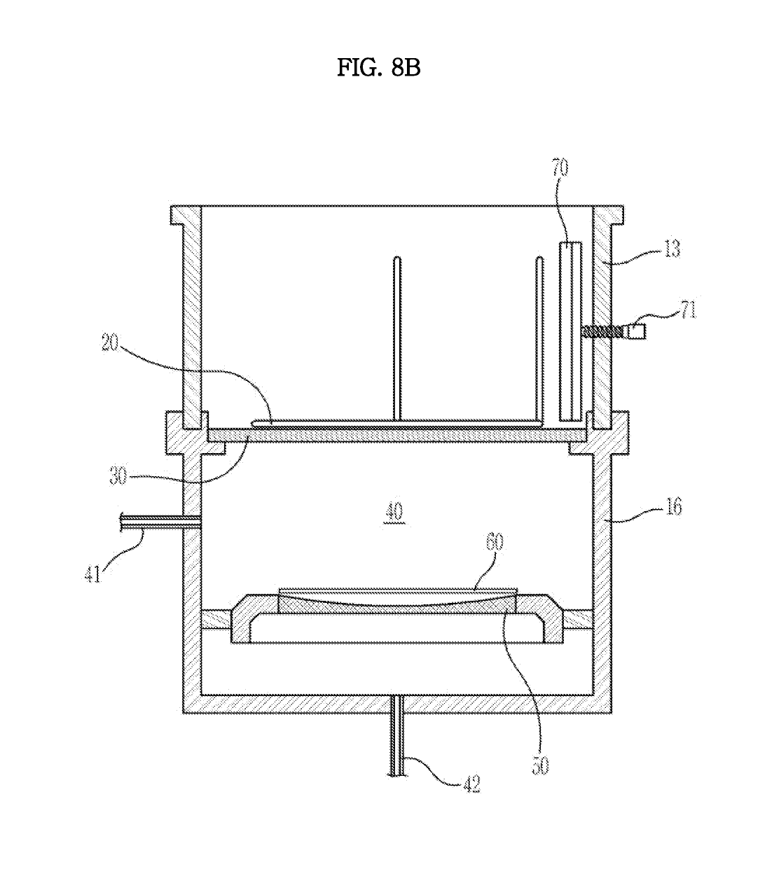

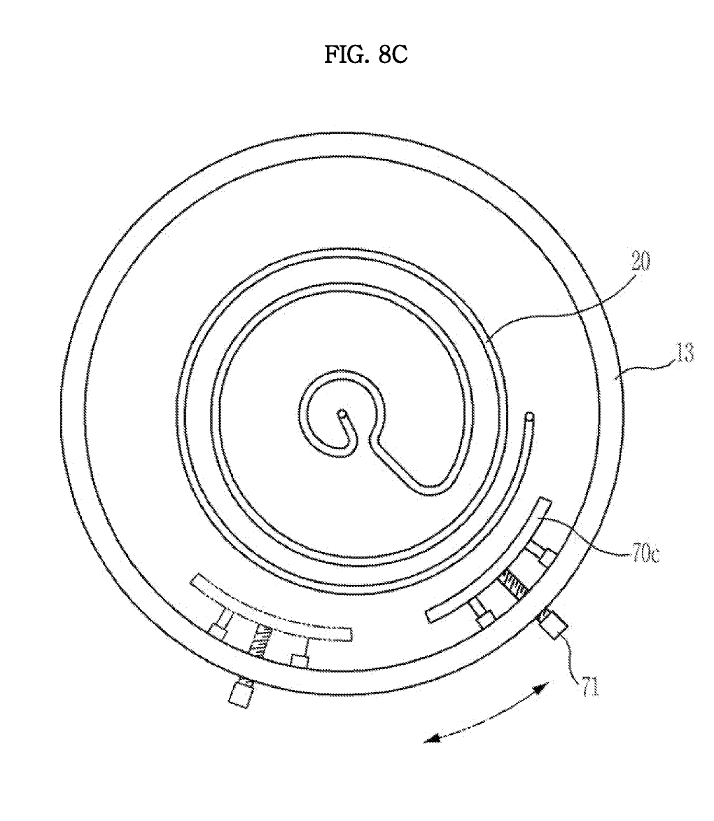

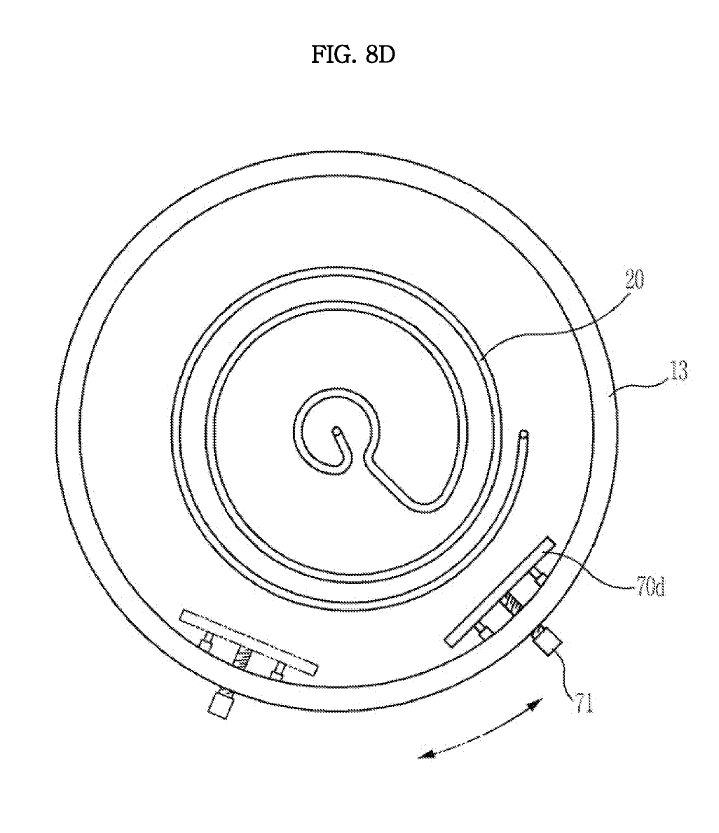

At least one of the magnetic field blocking member 70 may be installed. In a case where only one magnetic field blocking members 70 are installed, as illustrated in FIGS. 8A and 8B, the processing chamber 10 may be designed to rotate to adjust the position of the magnetic field blocking member 70. In a case when a plurality of the magnetic field blocking member 70 is being installed, as illustrated in FIGS. 5A, 5B, 6A, and 6B, the processing chamber 10 may not need to be designed to rotate.

With respect to the magnetic field blocking member 70, a gap distance from the antenna coil 20 may be adjusted. By adjusting the gap distance from the antenna coil 20 to the magnetic field blocking member 70, a portion of the magnetic field generated from the antenna coil 20 may be blocked so that the intensity of the inductive current generated at the dielectric panel 30 may be adjusted.

FIGS. 5A and 5B are drawings illustrating an operation of a magnetic field blocking member of a plasma processing apparatus in accordance with an example embodiment.

Referring to FIG. 5A, a plurality of magnetic field blocking members 70a extending in a circumferential direction at an inner wall of the processing chamber 10 are closely adhered at the inner wall of the processing chamber 10. Thus, the gap distance between the magnetic field blocking member 70a and the antenna coil 20 is far from each other. In a case when the magnetic field blocking member 70a is closely adhered to an inner wall of the processing chamber 10, the amount of the inductive current induced by the magnetic field, which is generated at the antenna coil 20 and reaches the dielectric panel 30, may be at a maximum state. At the reaction space 40 of the processing chamber 10, e.g., at the lower domain of the process chamber 10, the amount of the inductive current induced at the dielectric panel 30 may be at its maximum, and thus the density of the plasma also may be at its maximum. When the density of plasma is increased, the processing rate of the corresponding point of the sample 60 is also increased.

Referring to FIG. 5B, one of the magnetic field blocking members 70a extending in a circumferential direction at an inner wall of the processing chamber 10 is spaced apart from an inner wall of the processing chamber 10, and is adjacently positioned to the antenna coil 20. In a case where the magnetic field blocking member 70a is spaced apart from an inner wall of the processing chamber 10 and to be adjacent to the antenna coil 20, by blocking the magnetic field generated at the antenna coil 20, the inductive current may be at a minimum state. At the reaction space 40 of the processing chamber 10, e.g., at the lower domain of the process chamber 10, the amount of the inductive current induced at the dielectric panel 30 may be at its minimum. When the density of plasma is reduced, the processing rate of the corresponding point of the sample 60 is also reduced.

FIGS. 5A and 5B illustrate two situations, i.e., a situation that the magnetic field blocking member 70a is closest to the antenna coil 20 and another situation that the magnetic field blocking member 70a is farthest from the antenna coil 20. However, the magnetic field blocking member 70a may be positioned at any location between the two locations mentioned above, and depending on the distance between the magnetic field blocking member 70a and the antenna coil 20, the blocking degree of the magnetic field may be adjusted.

FIGS. 6A and 6B are drawings illustrating an operation of a magnetic field blocking member of a plasma processing apparatus in accordance with another example embodiment.

Referring to FIG. 6A, a plurality of magnetic field blocking members 70b provided in the shape of a plane panel at an inner wall of the processing chamber 10 are closely adhered at an inner wall of the processing chamber 10. Thus, the gap distance between the plurality of magnetic field blocking members 70b and the antenna coil 20 is far from each other. In a case where the magnetic field blocking member 70b is closely adhered to an inner wall of the processing chamber 10, the amount of the inductive current induced by the magnetic field, which is generated at the antenna coil 20 and reaches the dielectric panel 30, may be at a maximum state. At the reaction space 40 of the processing chamber 10, e.g., at the lower domain of the process chamber 10, the amount of the inductive current induced at the dielectric panel 30 may be at its maximum, and thus the density of the plasma may also be at its maximum. When the density of plasma is increased, the processing rate of the corresponding point of the sample 60 is also increased.

Referring to FIG. 6B, one of the magnetic field blocking member 70b extended in the shape of a plane panel at an inner wall of the processing chamber 10 is spaced apart from an inner wall of the processing chamber 10, and is adjacently positioned to the antenna coil 20. In a case when the magnetic field blocking member 70b is spaced apart from an inner wall of the processing chamber 10 and to be adjacent to the antenna coil 20, by blocking the magnetic field generated at the antenna coil 20, the inductive current may be at minimum state. At the reaction space 40 of the processing chamber 10, e.g., at the lower domain of the process chamber 10, the amount of the inductive current induced at the dielectric panel 30 may be at its minimum. When the density of plasma is reduced, the processing rate of the corresponding point of the sample 60 is also reduced.

FIGS. 6A and 6B illustrate two situations, i.e., one situation that the magnetic field blocking member 70b is as closest to the antenna coil 20 and another situation that the magnetic field blocking member 70b is farthest from the antenna coil 20 as an example. However, the magnetic field blocking member 70b may be positioned at any location between the two locations mentioned above, and depending on the distance between the magnetic field blocking member 70b and the antenna coil 20, the blocking degree of the magnetic field may be adjusted.

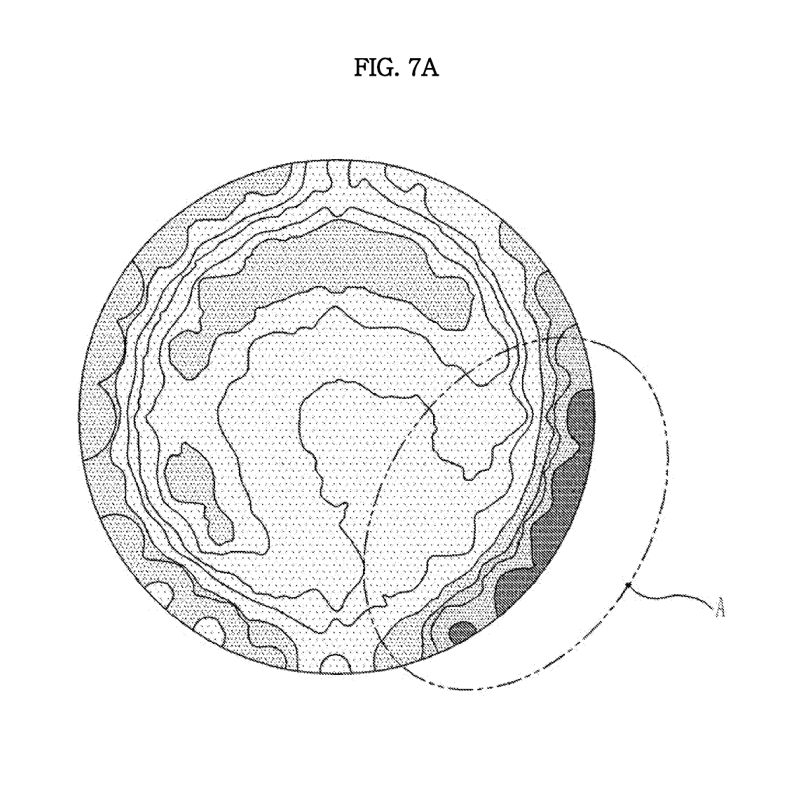

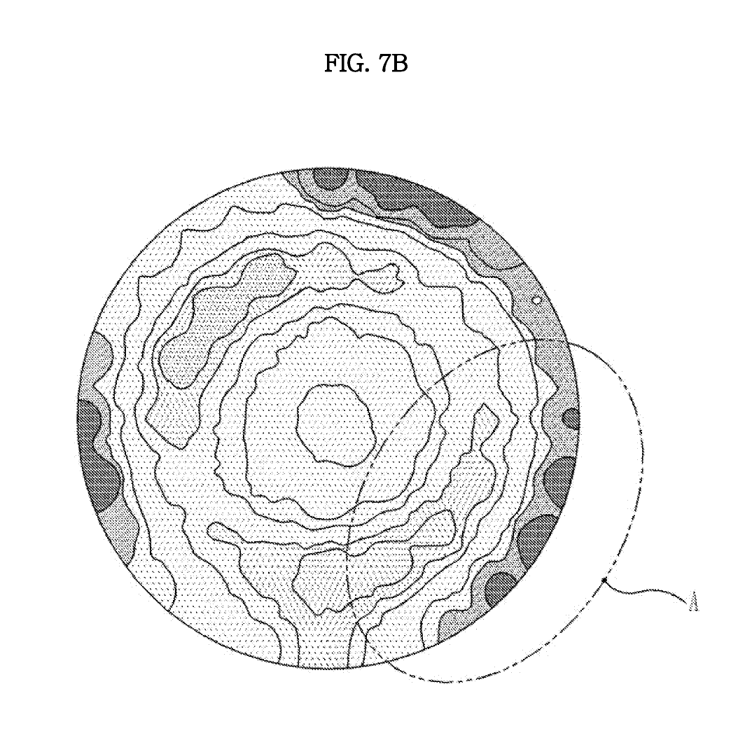

FIG. 7A is a drawing illustrating a state of a plasma-etched sample prior to providing a magnetic field blocking member in a plasma etching apparatus. FIG. 7B is a drawing illustrating a state of a plasma-etched sample after adjusting a gap distance using a magnetic field blocking member, which is provided in a plasma etching apparatus, in accordance with an example embodiment.

By referring to FIG. 7A, an area ‘A’ located at a 5 o'clock direction of the sample 60 is partially in an imbalanced state. The area ‘A’, compared to other areas, experiences relatively more etching, and thus has a thinner thickness. This phenomenon occurs when the plasma density at the area ‘A’ is higher as compared to the plasma densities of other areas. To perform a uniform and high-density etching process, the plasma density at the ‘A’ area is reduced. To reduce the plasma density at the ‘A’ area, the density of the inductive current at an upper domain of the processing chamber 10, which is vertically corresponding to the ‘A’ area, is reduced. To reduce the density of the inductive current, the distance between the antenna coil 20 and the magnetic field blocking member 70 is reduced.

Referring to FIG. 7B, the imbalanced state of the ‘A’ area at a 5 o'clock direction of the sample is resolved or reduced. For example, the magnetic field blocking member 70 positioned at the 5 o'clock direction of the sample 60 may be positioned adjacently to the antenna coil 20. When the magnetic field blocking member 70 and the antenna coil 20 are adjacent to each other, the magnetic field generated from the antenna coil 20 is partially blocked. When the magnetic field is partially blocked, the intensity of the inductive current is reduced. When the intensity of the inductive current is reduced, the density of the plasma is also reduced, and thereby reducing the etching rate at the area ‘A’ of the sample 60.

FIG. 8A is a partial schematic perspective view illustrating a magnetic field blocking member provided in a plasma processing apparatus in accordance with an example embodiment. FIG. 8B is a partial perspective view illustrating a magnetic field blocking member provided in a plasma processing apparatus in accordance with an example embodiment. FIG. 8C is a plane view illustrating a magnetic field blocking member provided in a plasma processing apparatus in accordance with another embodiment of the present disclosure. FIG. 8D is a plane view illustrating a magnetic field blocking member provided in a plasma processing apparatus in accordance with an example embodiment.

Referring to FIG. 8A, the plasma processing apparatus 1 may include an upper processing chamber 13, a lower processing chamber 16, an antenna coil 20, and a dielectric panel 30.

The lower processing chamber 16 is configured to form a reaction space 40, at which plasma is generated. At the lower processing chamber 16, a gas inlet unit 41, through which source gas is introduced, is provided. The source gas, in a case that the purpose of a process is an etching, may be at least one of gases, which is selected from SF₆, CH₂, HCl, CF₄, O₂, He, and Ar. The source gas, in a case that the purpose of a process is a deposition, may be at least one of gases, which is selected from SiH₄, CH₄, NH₃, and N₂. To uniformly supply reaction gas into the lower processing chamber 16, the gas inlet unit 41 may be provided in plurality.

At a lower domain of the lower processing chamber 16, a gas discharging unit 42 may be provided such that the reaction gas having completed a reaction and by-products from a processing may be discharged to an outside of the lower processing chamber 16. The position and the number of the gas discharging unit 42 may be adjusted in various manner. The gas discharging unit 42 may be connected to a vacuum pump (not shown). The vacuum pump may be configured to efficiently discharge the reaction gas having completed a reaction and by-products from a processing to an outside the lower processing chamber 16, and may also be configured to properly maintain the degree of vacuum at an inside the lower processing chamber 16.

At the upper portion of the reaction space 13, the antenna coil 20 may be positioned. The antenna coil 20 is connected to an upper power supply unit 43 that is configured to apply a radio-frequency power. Between the antenna coil 20 and the upper power supply unit 43, an upper impedance matching unit 44 may be provided.

Between an inner wall of the upper processing chamber 13 and the antenna coil 20, the dielectric panel 30 may be positioned. The antenna coil 20 and the dielectric panel 30 may be disposed in parallel to each other while having a predetermined space therebetween.

At a lower portion of the lower processing chamber 16, a lower electrode 50 may be provided. The lower electrode 50 may be in the form of a panel, and may be disposed in parallel to the dielectric panel 30. On the lower electrode 50, a sample 60 is placed, and thus the size of the lower electrode 50 may be larger than that of the sample 60. The lower electrode 50 is connected to a lower power supply unit 45 configured to apply a radio-frequency power. Between the lower electrode 50 and the lower power supply unit 45, a lower impedance matching unit 46 may be provided. When radio-frequency power is applied to the lower electrode 50, plasma may be formed in the reaction space 40 in a more uniform manner.

On the lower electrode 50, the sample 60, which is the subject of a treatment, may be placed. The sample 60 may be, e.g., a semiconductor wafer, a thin film transistor substrate of a liquid crystal display apparatus, or a color filter substrate of a liquid crystal display apparatus.

Inside the upper processing chamber 13, at least one of a magnetic field blocking member 70, which is configured to block a magnetic field generated at the antenna coil 20, may be installed. The magnetic field blocking member 70, by blocking a portion of the magnetic field generated at the antenna coil 20, may adjust the processing rate of the sample 60 placed on the lower electrode 50. The upper processing chamber 13 may rotate separately from the lower processing chamber 16. If the magnetic field blocking member 70 is adhered to the upper processing chamber 13, the circumferential position of the magnetic field blocking member 70 may change as the upper processing chamber 13 rotates. To block a portion of the magnetic fields generated from the antenna coil 20, a user, may further adjust the radial position of the magnetic field blocking member 70 so that the magnetic field blocking member 70 is disposed at a desired (or alternatively, predetermined) position. The magnetic field blocking member 70 installed at the upper processing chamber 13 may be rotated while connected to the upper processing chamber 13, and by the rotation of a coupling pin 71, the magnetic field blocking member 70 may be moved in an inner radial direction or in an outer radial direction of the upper processing chamber 13.

Referring to FIG. 8B, the magnetic field blocking member 70 may be provided between an inner wall of the upper processing chamber 13 and the antenna coil 20. The magnetic field blocking member 70 may be connected to an inner wall of the processing wall 10 using the coupling pin 71. The coupling pin 71 may be attached to the magnetic field blocking member 70. For example, the coupling pin 71 may be moved in an outer radial direction or in an inner radial direction of the processing chamber 10 by rotating the coupling pin 71. The coupling pin 71 may be rotated automatically or manually. For example, a step motor (not shown) may be connected to the coupling pin 71 and automatically rotate the coupling pin 71 by driving the step motor. The coupling pin 71 may be manually rotated by manually rotating the coupling pin 71. The degree of the coupling pin 71 rotation may be determined by checking a processing state of the sample 60. After checking thicknesses at a plurality of points of the sample 60, if the processing rate of a particular point is higher than other points, the inductive current of the upper vertical domain of the location, at which the particular point is positioned, is reduced. To reduce the inductive current at the upper vertical domain corresponding to the point having high processing rate, a position of the magnetic field blocking member (or some of the plurality of magnetic field blocking members) 70 is adjusted.

The magnetic field blocking member 70 is attached to an inner wall of the upper processing chamber 13. The position of the magnetic field blocking member 70 adhered at the upper processing chamber 13 may be changed by rotating the upper processing chamber 13. A user may change the position of the magnetic field blocking member 70 by rotating the upper processing chamber 13. A user may position the magnetic field blocking member 70 at a domain corresponding to the point where the plasma density is needed to be reduced.

Referring to FIG. 80, after positioning a magnetic field blocking member 70c at a domain corresponding to the point where the plasma density is needed to be reduced, the distance between the magnetic field blocking member 70c and the antenna coil 20 may be reduced by rotating the coupling pin 71, thereby reducing the current density induced at the dielectric panel 30.

Referring to FIG. 8D, a magnetic field blocking member 70d is provided in the shape of a plane panel. After positioning the magnetic field blocking member 70d at a domain corresponding to the point where the plasma density is needed to be reduced as described referring to FIG. 8C, the distance between the magnetic field blocking member 70d and the antenna coil 20 may be reduced by rotating the coupling pin 71, thereby reducing the current density induced at the dielectric panel 30.

In the example embodiments described above, the magnetic field blocking member 70 (including 70a-70d) being installed at the processing chambers 10 and 13 is used as an example for descriptions. However, any installation method or structural configuration having a shape capable of adjusting a gap distance with respect to the antenna coil 20 may be implemented within in the scope of the present inventive concepts. For example, a coupling member may be installed at an inner side of each processing chamber 10 and 13 and the magnetic field blocking member 70 may be installed at the coupling member, or a rotating member may be installed at an inner side of each processing chamber 10 and 13 and the magnetic field blocking member 70 may be installed at the rotating member.

Although a few example embodiments have been shown and described, it would be appreciated by those skilled in the art that changes may be made in these embodiments without departing from the principles and spirit of the present inventive concepts, the scope of which is defined in the claims and their equivalents.

What is claimed is:

1. A plasma processing apparatus comprising:
a processing chamber;
an antenna coil inside the processing chamber, the antenna coil configured to generate a magnetic field; and
a magnetic field blocking member configured to block the magnetic field generated at the antenna coil such that an intensity of the magnetic field is controlled by adjusting a gap distance between the magnetic field blocking member and the antenna coil.

2. The plasma processing apparatus of claim 1, wherein the magnetic field blocking member is installed at an inner side of the processing chamber by a coupling pin, the coupling pin is rotatable, and the magnetic field blocking member is configured to move at least one of toward an inner side direction of the processing chamber and toward an outer side direction of the processing chamber by rotating the coupling pin.

3. The plasma processing apparatus of claim 2, wherein the magnetic field blocking member is configured in a way that, as the magnetic field blocking member moves toward the inner side direction of the processing chamber to be nearer to the antenna coil, the amount of the magnetic field blocked by the magnetic field blocking member is increased.

4. The plasma processing apparatus of claim 2, wherein the magnetic field blocking member is configured in a way that, as the magnetic field blocking member moves toward the outer side direction of the processing chamber to be farther away from the antenna coil, the amount of the magnetic field blocked by the magnetic field blocking member is reduced.

5. The plasma processing apparatus of claim 1, further comprising:
a dielectric panel inside the processing chamber such that an induced current is generated as the magnetic field penetrates through the dielectric panel.

6. The plasma processing apparatus of claim 5, wherein
the processing chamber defines a reaction space therein and the plasma is generated at the reaction space by the magnetic field of the induced current generated at the dielectric panel, and
a lower electrode is provided at the reaction space and a sample to be etched by the plasma is placed on the lower electrode.

7. The plasma processing apparatus of claim 6, wherein the magnetic field blocking member is provided in the processing chamber, the magnetic field blocking member configured to move in a circumferential direction of the antenna coil to a position above the sample and configured to move in a radial direction of the processing chamber to adjust the gap distance between the magnetic field blocking member and the antenna coil.

8. A plasma processing apparatus, comprising:
an upper processing chamber provided with an antenna coil, the antenna coil configured to generate a magnetic field by using a radio-frequency power from a power supply unit; and
a lower processing chamber configured to house a sample to be processed by a plasma, a density of the plasma configured to be adjusted according to an intensity of the magnetic field of the antenna coil,
a magnetic field blocking member at the upper processing chamber, the magnetic field blocking member configured to move in a radial direction of the antenna coil to adjust a gap distance between the magnetic field blocking member and the antenna coil.

9. The plasma processing apparatus of claim 8, wherein the magnetic field blocking member is installed at an inner side of the upper processing chamber by a coupling pin, the coupling pin is rotatable, and the magnetic field blocking member is configured to move at least one of toward an inner side direction of the upper processing chamber and toward an outer side direction of the upper processing chamber by rotating the coupling pin.

10. The plasma processing apparatus of claim 9, wherein the magnetic field blocking member is configured in a way that, as the magnetic field blocking member moves toward the inner side direction of the upper processing chamber to be nearer to the antenna coil, the amount of the magnetic field blocked by the magnetic field blocking member is increased.

11. The plasma processing apparatus of claim 9, wherein the magnetic field blocking member is configured in a way that, as the magnetic field blocking member moves toward the outer side direction of the upper processing chamber to be farther away from the antenna coil, the amount of the magnetic field blocked by the magnetic field blocking member is reduced.

12. The plasma processing apparatus of claim 8, further comprising:
a dielectric panel at a border of the upper processing chamber and the lower processing chamber such that an induced current is generated as the magnetic field penetrates through the dielectric panel.

13. The plasma processing apparatus of claim 12, wherein the lower processing chamber defines a reaction space therein, and the plasma is generated at the reaction space by the magnetic field of the induced current generated at the dielectric panel, and
a lower electrode is provided at the reaction space and a sample to be processed by the plasma is placed on the lower electrode.

14. The plasma processing apparatus of claim 13, wherein the magnetic field blocking member is provided in the upper processing chamber,
the magnetic field blocking member configured to move in a circumferential direction of the antenna coil to a position above the sample and configured to move in a radial direction of the upper processing chamber to adjust a gap distance between the magnetic field blocking member and the antenna coil.

15. A plasma processing apparatus, comprising:
a processing chamber including a first processing area and a second processing area;
an antenna coil in the first processing area, the antenna coil configured to generate a magnetic field;
a dielectric plate between the first processing area and the second processing area, the dielectric plate configured to generate an inductive current by the magnetic field, the inductive current generating a plasma in the second processing area; and
at least one magnetic field blocking member in the first processing area, the at least one magnetic field blocking member configured to control an intensity of the magnetic field by adjusting a gap distance between the at least one magnetic field blocking member and the antenna coil.

16. The plasma processing apparatus of claim 15, wherein the at least one magnetic field blocking member is configured to move in a circumferential direction with respect to a circumference of the first processing area and is configured to move in a radial direction with respect to a center of the first processing area.

17. The plasma processing apparatus of claim 15, the first processing area is configured to move separately from the second processing area.

18. The plasma processing apparatus of claim 15, the first processing area and the at least one magnetic field blocking member are coupled with each other and move together in a circumferential direction with respect to a circumference of the first processing area.

19. The plasma processing apparatus of claim 15, the at least one magnetic field blocking member is a plurality of magnetic field blocking members.

20. The plasma processing apparatus of claim 19, wherein positions of each of the plurality of magnetic field blocking members is configured to be adjusted separately from each other.
